(19) United States
(12) Patent Application Publication
(10) Pub. No.: US 2007/0209214 A1
(43) Pub. Date: Sep. 13, 2007

(54) Hybrid scissor and razor

(76) Inventors: Takayuiki Kamemura, Laval (CA); Luc Vincent, Vaudreuil Dorion (CA)

Correspondence Address: Robert G. Hendry, 1240 Lassiter Terrace, Ottawa, K1J 8N1, CA

(21) Appl. No.: 11/715,978

(22) Filed: Mar. 9, 2007

(30) Foreign Application Priority Data
Mar. 9, 2006 (CA) 2,538,975

(51) Int. Cl. B26B 13/00

(52) U.S. Cl. 30/233

(57) ABSTRACT

A combination hair cutting tool includes scissors and razor. The tool allows the user to cut hair efficiently either using the scissors in a conventional manner or, alternatively, using the razor located on the scissors without the need to switch to a dedicated single-purpose tool.

### BACKGROUND OF THE INVENTION

1. Field of the Invention

This invention relates to a hair razor and more particularly to hair cutting scissors adapted to retain a blade guard and razor blade.

2. Prior Art

In U.S. Pat. No. 4,805,305 a first jaw of a pair of scissors has a recess for securing a razor within the scissors and this changes the manner in which the pair of scissors is operated.

Hair trimming razors having finger rings on the rear or other handle portions through which a person's fingers may be inserted, are known and disclosed in U.S. Pat. No. 6,092,288. However, the razor is in the patent is not provided on the outer edge of a pair of scissors although the finger ring is provided on the razor. It will also be appreciated that a skilled user of the combination scissor and razor of this invention can cut hair with the scissors or use the razor without laying down the scissor or the razor.

It is an object of this invention to save working time by providing a dual purpose hair cutting tool.

### SUMMARY OF THE INVENTION

Accordingly the present invention seeks to provide a hair styling razor and hair cutting scissors comprising: a blade guard and razor blade, a handle portion, a recess in the handle portion to receive and retain the blade guard and blade and a second handle portion pivotally secured to the first handle portion forming the hair cutting scissors.

### BRIEF DESCRIPTION OF THE DRAWINGS

FIG. 1 is a perspective view of the razor blade and part of the scissors.

FIG. 2 is a plan view of the razor blade and scissors.

FIG. 3 is a diagrammatic exploded end view of the scissor blade construction.

FIG. 4 is a cross section taken along the line 44 of FIG. 1.

FIG. 5 is an exploded of an alternative construction of the scissor blade.

FIG. 6 is a cross sectional view of the scissor blade assembly of FIG. 5.

FIG. 7 is a perspective view of a blade guard; and

FIG. 8 is a side view of the blade in the blade guard.

### DETAILED DESCRIPTION OF A PREFERRED EMBODIMENT

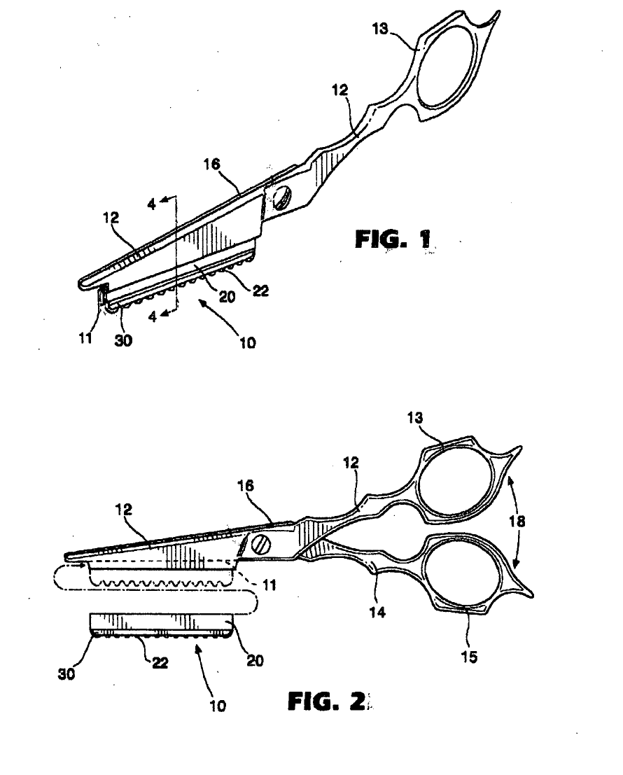

As shown in FIG. 1 a razor blade holder 10 including a blade holder slot 11, a handle portion 12 and a finger ring 13. The finger ring 13 on the handle 12 has the dimensions of a standard scissor 18. The blade holder slot 11 houses a razor blade guard 20 containing a razor blade 30 and intermittent protrusions 22 cover portions of the razor blade 30. The razor blade 30 is prepackaged in this manner within the blade holder 10.

As shown in FIG. 2 the hybrid scissors and razor blade 35 also includes a second handle and scissor blade portion 14 provided with a finger ring 15. A sharpened scissor blade (not shown) is provided on the scissor blade portion 14. The second scissor blade and handle 14 is pivotally attached to the first handle portion 12.

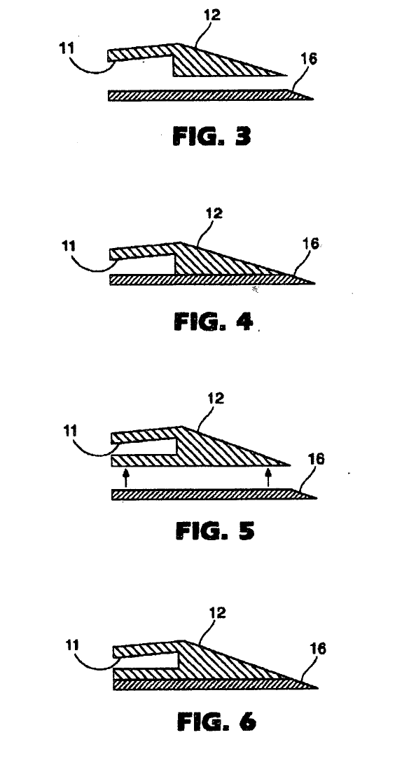

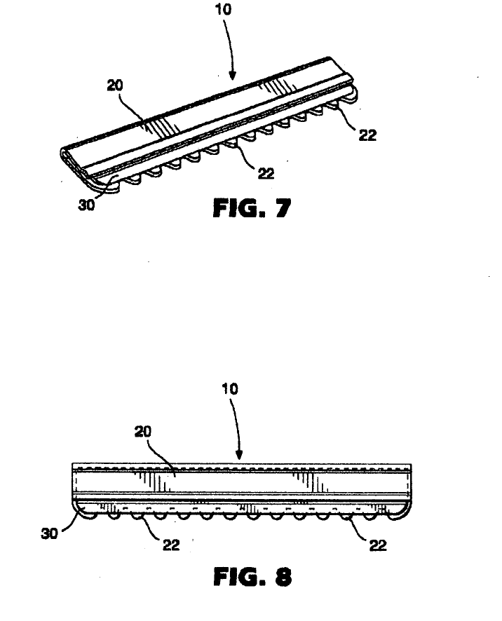

The blade holder 10 is inserted into the blade holder slot 11 in a known manner. As shown in FIGS. 3 and 4 the blade holder slot 11 comprises a separate blade 16 of suitable steel welded to a handle portion 12 having the blade holder slot 11. Similarly, as shown in FIGS. 5 and 6 the blade 16 is welded to the handle portion 12, which is provided with the blade holder slot 11.

When the razor blade holder and scissor combination 10 is used by a hair stylist, the hair is combed with the razor blade and scissor combination 10 until all the hair has been treated. During this process the stylist would be able to interchange the use of the razor blade 30 and the scissors 18, while retaining both in one hand and without setting down and picking up one or other of the tools.

1. A hybrid hair styling razor and hair cutting scissors for use with a razor blade and a blade guard, said hybrid hair styling scissors comprising:
a first scissor blade portion and a first handle portion
a recess in an outer edge of the first scissor blade portion to receive and retain the blade guard and razor blade
and a second handle portion pivotally secured to the first handle portion so as to form the hair cutting scissors.

2. The hybrid hair styling razor and hair cutting scissors of claim 1 wherein the scissor blade is a separate relatively thin blade of suitable metal welded to a blade portion of the first handle portion shaped to provide the recess in the outer edge of the first scissor blade portion when combined with the thin blade to receive and retain the blade guard and razor blade.
